(19) United States
(12) Patent Application Publication
(10) Pub. No.: US 2007/0177238 A1
(43) Pub. Date: Aug. 2, 2007

(54) Temperature stable color coded chip

(75) Inventor: Fred N. Miekka, Arcadia, CA (US)

Correspondence Address: FRANK A. PALASE, SUITE 203, 141 E. HUNTINGTON DRIVE, ARCADIA, CA, 91006, US

(73) Assignee: SIERRA MADRE MARKETING GROUP

(21) Appl. No.: 11/700,931

(22) Filed: Feb. 1, 2007

Related U.S. Application Data
(60) Provisional application No. 60/764,097, filed on Feb. 1, 2006.

(51) Int. Cl. G03H 1/00

(52) U.S. Cl. 359/2

(57) ABSTRACT

Multicolored glass and/or mineral chips are disclosed. Coded information provides the benefit of part verification, authentication of origin, and anti-counterfeit protection. Numerous combinations are provided by color coding using the base ten system. Coloring may be carried out in glass, high temperature ceramic, or minerals such as quarz and alumina. The resulting chips have a high degree of stability to high temperatures and other environmental conditions.

### CROSS REFERENCE TO RELATED APPLICATIONS

This non-provisional application claims benefit of the provisional application filed on Feb. 1, 2006 having application number U.S. 60/764,097.

### BACKGROUND OF THE INVENTION

1. Field of the Invention

This invention relates to product traceability and more particularly to small chips having color coded grids that are inherently resistant to damage from exposure to sunlight, water, chemical attack, and high temperature.

2. Description of the Related Art

There are numerous methods that may be employed to provide verification of objects and parts.

When objects are placed within the volume of a sealant such as a bonding agent they may be said to be embedded. Embedding articles within bonding agents and/or other sealants may help to protect them from environmental stresses such as moisture, heat, and vibration.

Certain articles may be embedded within other articles for various purposes such as identification, anti-theft, and anti-counterfeit protection. The use of anti-theft protection is becoming more widespread throughout the retail industry. Small circuits having a tuned frequency response may be placed into consumer goods located in retail stores. A powerful electromagnet may then be used at the point of sale to induce a strong current in the circuit to burn it out and thus render it inoperable. The burned out circuit can then pass through a sensor without setting off the alarm. If however a functioning circuit passes by the sensor, the alarm activates indicating possible theft. These embedded circuits can be made low enough in cost to provide an overall savings to the retailer by reducing theft.

Counterfeit products are commonly sold to consumers. These counterfeit products may be labeled as originals and sold fraudulently. This may result in reduced sales of legitimate products and may even add to product liability from the use of the inferior counterfeit product.

Numerous methods may be employed to help prevent the counterfeiting and forgery of commercial items. For example, holographic images are being increasingly used to deter counterfeiting and forgery. Holographic stickers are often applied to credit cards to reduce counterfeiting and forgery. Holographic images are images having optical depth and/or refractive color properties resulting from small grooves producing diffraction effects with light. Since an optical copy of a holographic image does not refract light, it is easy to distinguish from the original. Holographic image stickers may be designed to fall apart if tampered with to prevent them from being transferred to other items. In addition it is common practice to place these stickers over the raised numbers of a credit card to further discourage their transfer. Unfortunately, holograms are plentiful and there are so many different credit cards out there, placing any hologram on a counterfeit credit card would fool many individuals. Furthermore, holograms can be copied by casting polymers over the original embossed image.

One particularly interesting approach to employing holographic images for producing counterfeit resistant items is outlined in U.S. Pat. No. 5,624,076 awarded to Richard G, Miekka and others titled “Process for making embossed metallic leafing pigments” This particular patent outlines a process for preparing metal leafing pigments having surface embossment. The surface embossment may take the form of a diffraction image pattern such as a diffraction grating or hologram. The process involves expensive metallization equipment and therefore would be expensive to reproduce. The result is finely divided thin metal film particles having micro-embossment on at least one surface. These embossed leafing pigments have unique optical properties that are visible to the naked eye and can be further analyzed by optical magnification.

One interesting property of these thin metallic embossed leafing pigments is the fact that the embossment remains on the pigment particles despite their exceedingly small thickness of only a few hundred angstroms. About 100 atoms thick for aluminum.

U.S. Pat. No. 5,672,410 also awarded to Richard G, Miekka and others titled “Embossed Metallic Leafing Pigments” gives a detailed description of the leafing pigments themselves. U.S. Pat. No. 6,068,691 awarded to Richard G, Miekka and others titled “Process for making machine readable images” employs embossed metallic leafing pigments having a machine readable pattern such as micro-embossed bar codes.

Difficulties associated with the process along with initial expense of equipment, helps to deter the counterfeiting of embossed metallic leafing pigments.

Other anti-counterfeit technologies include watermarks in paper, hidden printing and/or images in fluorescent inks, and micro-printing.

The numerous available anti-counterfeit technologies cover a wide range of uses and applications. Unfortunately, while each may have particular positive attributes, It may be desirable to provide a method of providing product traceability and/or anti-counterfeit properties that are suitable for use in harsh environments. This may be especially true with respect to ultra high temperature stability.

Certain metal oxides are known to provide specific coloring to minerals, ceramics, and glass. For example, rubies are red due to the incorporation of chromium oxide within the crystalline lattice of aluminum oxide. A ruby is exceedingly difficult to destroy by heat. The melting point of aluminum oxide is 3,632 degrees F. and therefore the ruby itself is one of the most heat resistant materials known to man.

If a small sample of aluminum oxide powder is mixed with a small quantity of a chromium compound such as chromium oxide, a heterogeneous mixture results. If the flame of an oxy-acetylene torch is applied to the top of a pile of such a mixture, the aluminum oxide will first emit a very bright light. The aluminum oxide will then melt and mix with the chromium compound. On cooling, the bright emitted light will subside and the mass will turn dark in color. On further cooling, the red color associated with ruby will be present. It should be noted that artificial ruby produced in this manner has the same properties as its natural cousin including the property of fluorescence. Sapphires are blue in color because of other metal oxides such as titanium dioxide. Aluminum oxide colored by many metal oxides has good heat resistance properties. For example, rubies can withstand high temperatures associated with fire without damage. In particular, metal oxide colored forms of aluminum oxide can withstand temperatures exceeding 1000 degrees F. and will return to their original color on cooling.

Ceramics are mixtures of materials having good high temperature properties and may be considered somewhat heterogeneous on a microscopic scale. Like aluminum oxide, ceramics can be colored by the incorporation of small amounts of certain metal oxide substances.

Glass is a material usually based on silica having the unique property of no specific melting point. Glass is often made by combining two or more elemental oxides and melting them together. The resultant material is inhibited from crystallizing due to one or more elemental oxides interfering with the crystalline properties of the other. There are numerous glass compositions available. The interesting property of glass is that it may be considered an ultra high viscosity liquid. Glass therefore may not have a specific melting point but rather a temperature range where it may be worked or even poured. Glass may be colored by specific metal oxides thereby providing numerous possible color combinations.

It is an object of this invention to provide product traceability.

It is a further object of this invention to provide optical readability.

It is a further object of this invention to provide resistance to degradation by extreme temperatures.

It is a further object of this invention to provide anti-counterfeit protection to consumer articles and the like.

Finally, it is an object of this invention to provide an optically readable chip suitable for part verification at a later date.

### SUMMARY OF THE INVENTION

In summary, this invention proposes a matrix based color coded chip made of high temperature materials stable to harsh environments that can be easily read under optical magnification.

### BRIEF DESCRIPTION OF THE DRAWINGS

FIG. 1 shows a 2×5 color coded matrix consisting of circular dots.

FIG. 2 shows a color coded chip formed from fusing circular glass dots to the top surface of a glass blank.

FIG. 3 shows a cross sectional view of color coded glass beads fused to a glass substrate.

FIG. 4 shows a color coded chip embedded into the head of a bullet.

FIG. 5 shows a color coded chip formed from fusing glass squares to the top surface of a glass blank.

### DESCRIPTION OF THE INVENTION

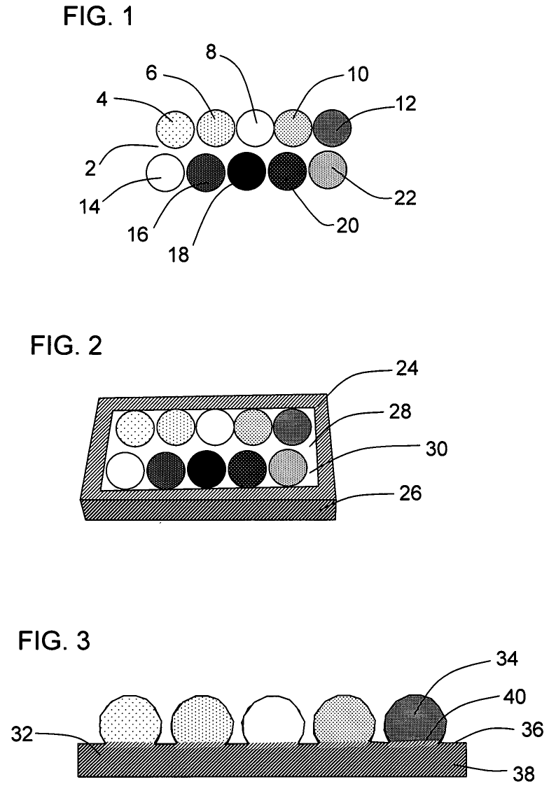

FIG. 1 shows a 2×5 color coded matrix consisting of circular dots. Color coded matrix 2 is shown composed of colored glass beads. Color coded glass bead 4 is gold in color and is used to start the sequence. In this case, the sequence starts at the left hand upper corner and reads left to right top to bottom in the traditional English format. The following color code is used in this case.

### Start indicator=Gold

### 0=Silver

### 1=White

### 2=Red

### 3=Orange

### 4=Yellow

### 5=Green

### 6=Blue

### 7=Violet

### 8=Grey

### 9=Black

Colored glass bead 6 is silver and corresponds to 0. Colored glass bead 8 is white and corresponds to 1. Colored glass bead 10 is yellow and corresponds to 4. Colored glass bead 12 is green and corresponds to 5. Colored glass bead 14 is white and corresponds to 1. Colored glass bead 16 is blue and corresponds to 6. Colored glass bead 18 is black and corresponds to 9. Colored glass bead 20 is blue and corresponds to 6. Finally, colored glass bead 22 is red and corresponds to 2. The sequence of numbers outlined in FIG. 1 is 014516962 or 14,516,962. Thus a small color coded 2×5 matrix represents almost one billion possible combinations. Based on the base 10 number system, each color bead increases the possible combinations by a factor of ten. Thus a 3×5 matrix would have one hundred trillion possible combinations. It should be noted that colored glass beads can be made by melting glass with various metal oxides. The result is a colored glass bead resistant to fading and capable of withstanding high temperatures without damage. It should be noted that if higher melting substances such as aluminum oxide are used, excellent heat resistance may be obtained.

FIG. 2 shows a color coded chip 24 formed from fusing circular glass dots to the top surface of glass blank 26. Color coded glass chip 24 is shown having a matrix 28 of color coded glass beads fused onto top surface portion 30.

FIG. 3 shows a cross sectional view of color coded glass beads fused to a glass substrate. Color coded glass chip 32 is shown in cross sectional form. Colored glass beads 34 are fused onto the top surface portion 36 of glass substrate 38. Also shown is attachment zone 40 between colored glass beads 34 and glass substrate 38. Attachment zone 40 represents a strong bond owing to the fact that fusion has occurred between colored glass beads 34 and glass substrate 40.

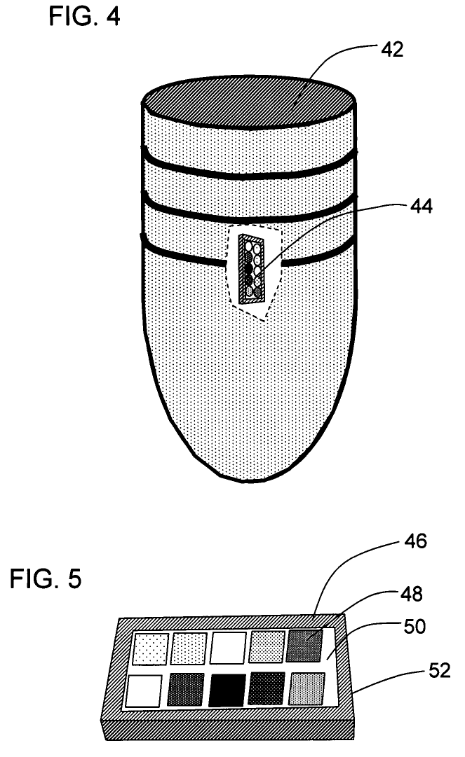

FIG. 4 shows a color coded chip embedded into the head of a bullet. Microchip tagged bullet head 42 is shown having glass color coded microchip 44 embedded into the center. Glass microchip 44 is stable to the melting point of lead and therefore may be cast into the lead portions of ammunition. It should be noted that these glass chips may be later retrieved by melting the lead away. Once retrieved, they can be decoded and traced back to point of origin.

FIG. 5 shows a color coded chip formed from fusing glass squares to the top surface of a glass blank. Color coded chip 46 is shown consisting of colored glass squares 48 fused onto top portion 50 of glass substrate 52.

Those skilled in the art will understand that the preceding exemplary embodiments of the present invention provide foundation for numerous alternatives and modifications. These other modifications are also within the scope of the limiting technology of the present invention. Accordingly, the present invention is not limited to that precisely shown and described herein but only to that outlined in the appended claims.

What is claimed is:

1. A temperature stable color coded chip comprising:
A material stable to high temperatures and a pattern of color coded zones,
Said color coded zones of said temperature stable color coded chip being dispersed within said material stable to high temperature of said temperature stable color coded chip and said color coded zones containing at least one metal salt capable of tinting said material stable to high temperatures.
